(19) United States
(12) Patent Application Publication
(10) Pub. No.: US 2018/0128217 A1
(43) Pub. Date: May 10, 2018

(54) BLOW-OFF VALVE

(71) Applicant: Continental Automotive GMBH, Hannover (DE)

(72) Inventor: Rosario Bonanno, Bad Soden (DE)

(73) Assignee: CONTINENTAL AUTOMOTIVE GMBH, Hannover (DE)

(21) Appl. No.: 15/864,390

(22) Filed: Jan. 8, 2018

Related U.S. Application Data
(63) Continuation of application No. PCT/EP2016/065588, filed on Jul. 1, 2016.

(30) Foreign Application Priority Data
Jul. 9, 2015 (DE) 10 2015 212 913.6

(51) Int. Cl. F02M 35/10; F16K 31/06

(52) U.S. Cl. CPC F02M 35/10236; F02M 35/10249; F02M 35/10157; F16K 31/0655

(57) ABSTRACT

A blow-off valve for controlling the pressure in an intake tract of an internal combustion engine, comprising a housing and a flow path formed in the housing, wherein the flow path is opened and/or closed by means of piston, which may be placed onto valve seat, wherein the piston is connected to a pin, which is moved by means of an electromagnetically producible force, wherein motion of the pin is transferred to the piston, wherein the support of the pin within the blow-off valve is realized by means of exactly one sliding sleeve, wherein the pin is moved in relation to the sliding sleeve.

### CROSS-REFERENCE TO RELATED APPLICATIONS

This application claims the benefit of PCT Application PCT/EP2016/065588, filed Jul. 1, 2016, which claims priority to German Patent Application 10 2015 212 913.6, filed Jul. 9, 2015. The disclosures of the above applications are incorporated herein by reference.

### FIELD OF THE INVENTION

The invention relates to a blow-off valve for regulating the pressure in an intake section of an internal combustion engine, having a housing and having a flow section formed in the housing, wherein the flow section is opened and/or closed by a piston which may be seated on a valve seat, wherein the piston is connected to a pin which is moved by means of an electromagnetically producible force, wherein a movement of the pin is transferred to the piston.

### BACKGROUND OF THE INVENTION

In drive systems having an internal combustion engine and a turbocharger, so-called blow-off valves are used to prevent the generation of high dynamic pressures between the throttle valve and the turbocharger. Such a high dynamic pressure may build up for example when the throttle flap is closed abruptly following a state in which there is a high operating load, i.e. a high rotational speed of the turbocharger. The build-up of dynamic pressure here may lead to a marked deceleration of the turbocharger, which is disadvantageous for the operation of the turbocharger. A sudden opening of the throttle valve may also have a disadvantageous effect since an intense drop in pressure downstream of the turbocharger may occur, which may generate the so-called turbo lag.

The blow-off valve is therefore used to prevent an excessive build-up of pressure downstream of the turbocharger owing to the accelerator being released, so-called coasting. To this end, a bypass channel is opened, which enables the air between the turbocharger and the throttle valve to flow around the turbocharger so that this air may be delivered through the turbocharger again as required. The blow-off valve is controlled in different ways to keep the pressure between the turbocharger and the throttle valve at a constant level.

Pneumatically regulated blow-off valves are known in the prior art. These valves are primarily controlled via underpressure regulation. Electromagnetic blow-off valves are moreover known, which are controlled via a control device. A metal pin, which is connected to a piston, is moved in opposition to a restoring force of a mechanical spring here by an electromagnetic field in order to open a flow path which is closed by the piston or to close the flow path. To ensure precise guidance of the piston and/or the metal pin, devices are known in the prior art which provide a dual bearing of the metal pin. To this end, the pin is supported with respect to a housing at at least two mutually independent points.

Such dual bearings are, in particular, disadvantageous in that it is necessary to create at least two fits with narrow tolerances between the pin and the bearing elements. It is also necessary to create fits with low tolerances in each case between the bearing elements and the housing. The assembly of such a blow-off valve is very complex and the tolerance chain generated may result in particularly high tilt angles of the pin, whereby the functionality and, in particular, the precision of the blow-off valve are greatly impaired.

### SUMMARY OF THE INVENTION

It is therefore the object of the present invention to create a blow-off valve for use in a drive system having an internal combustion engine and having a turbocharger, which has a simplified bearing of the pin and the piston and therefore enables simpler assembly and more precise opening and closing of the blow-off valve.

An exemplary embodiment of the invention relates to a blow-off valve for regulating the pressure in an intake section of an internal combustion engine, having a housing and having a flow section formed in the housing, wherein the flow section is opened and/or closed by a piston which may be seated on a valve seat, wherein the piston is connected to a pin which is moved by means of an electromagnetically producible force, wherein a movement of the pin is transferred to the piston, wherein the bearing of the pin within the blow-off valve is realized by precisely one sliding sleeve, wherein the pin is movable relative to the sliding sleeve.

A blow-off valve enables an intake section upstream of an internal combustion engine to be vented. To this end, the blow-off valve opens a flow path through which the fluid escapes from the intake section. The fluid, which is preferably formed by air or by an air/fuel mixture, advantageously escapes from the intake section and is supplied again to another suitable point, for example in the flow direction upstream of the turbocharger.

The bearing for the pin with precisely only one sliding sleeve is advantageous since the tolerances within the bearing are determined only by the tolerances of the sliding sleeve and the pin. The possible tilting errors of the pin within the sliding sleeve are determined only by the tolerance chain of the two elements. In contrast with a bearing having at least two bearing elements arranged at a spacing from one another, this is particularly advantageous since there are fewer disruptive influences owing to the smaller number of parts.

The sliding sleeve advantageously encompasses the pin over a relatively long extent in the axial direction in order to ensure as precise a guidance of the pin as possible. The sliding sleeve particularly preferably encompasses the pin in the axial direction over an extent which is greater than half the axial extent of the pin.

It is particularly advantageous if the sliding sleeve is received in a bearing sleeve and the bearing sleeve is arranged in the housing of the blow-off valve. To position the sliding sleeve advantageously in the blow-off valve, it is preferably received in a bearing sleeve which is itself received in the housing of the blow-off valve. It is therefore possible to carry out a simple adaptation of the sliding sleeve to the bearing sleeve or vice versa. An accurately fitting alignment of the sliding sleeve may thus also be achieved in a simple manner in different housings of a blow-off valve.

It is also advantageous if, in terms of its shaping, the inner lateral surface of the sliding sleeve follows the outer lateral surface of the pin, wherein a fit is created between the sliding sleeve and the pin which enables the pin to slide in the sliding sleeve. This is particularly advantageous for producing as large a sliding surface as possible between the pin and the sliding sleeve. The play between the sliding sleeve and the pin is preferably particularly small to prevent or minimize a tilting of the pin in the sliding sleeve.

A preferred exemplary embodiment is characterized in that the sliding sleeve has a first region having a first outer diameter and a second region having a second outer diameter, wherein the first outer diameter is smaller than the second outer diameter.

Such a design is particularly advantageous for ensuring simple assemblability of the sliding sleeve. In particular, if the sliding sleeve is pressed into the bearing sleeve, the sliding sleeve may be introduced particularly easily into the bearing sleeve owing to the region having the smaller outer diameter. A reduction in the contact surfaces resulting from the region having a smaller outer diameter is also advantageous for keeping the required assembly forces as low as possible.

It is also preferable if the bearing sleeve has a first portion having a first inner diameter and a second portion having a second inner diameter, wherein the first inner diameter is smaller than the second inner diameter.

Such a design is advantageous in particular in conjunction with the above-described design of the sliding sleeve, since it is thus possible to define contact points between the sliding sleeve and the bearing sleeve in a simple manner without thereby producing contact between the sliding sleeve and the bearing sleeve over the entire axial extent of the sliding sleeve or the bearing sleeve. This facilitates the assembly and minimizes the deformation resulting from the pressing procedure. Stresses occurring in the material are also minimized. By designing the bearing sleeve with a portion having a larger inner diameter, the introduction of the sliding sleeve is in particular simplified if the portion is arranged at an axial end region of the bearing sleeve.

It is moreover advantageous if the sliding sleeve abuts with the outer surface of the first region against the inner surface of the first portion of the bearing sleeve and the sliding sleeve abuts with the outer surface of the second region against the inner surface of the second portion of the bearing sleeve. This is particularly advantageous for producing a stable support of the sliding sleeve in the bearing sleeve without producing an unnecessarily large contact surface between the sliding sleeve and the bearing sleeve. This additionally simplifies the assembly.

It is furthermore advantageous if the sliding sleeve is pressed into the bearing sleeve. The play between the sliding sleeve and the bearing sleeve is thus minimized or completely eliminated. A secure seat of the sliding sleeve in the bearing sleeve may therefore be achieved.

It is also expedient if the bearing sleeve is pressed into the housing. This is advantageous for ensuring a reliable and precise seat of the bearing sleeve in the housing.

It is moreover advantageous if the sliding sleeve has recesses extending along its outer surface in the axial direction, whereby the outer surface is divided into segments which are spaced from one another in the circumferential direction.

The recesses, which may be milled for instance in the outer surface of the sliding sleeve, form air channels through which, in particular, a pressure equalization is produced in the housing of the blow-off valve. It is therefore possible to enable an air exchange in particular between the clearance above the sliding sleeve and the region in the housing of the blow-off valve below the sliding sleeve. The channels produced by the recesses preferably extend between the sliding sleeve and the bearing sleeve. The elevated segments generated between the recesses are preferably spaced from one another in the circumferential direction of the sliding sleeve by the recesses. It is advantageous to produce at least three elevated segments to ensure reliable positioning of the sliding sleeve in the bearing sleeve and prevent tilting.

It is furthermore expedient if a magnetic element is arranged in the portion having the second inner diameter of the bearing sleeve, which magnetic element is inserted into the bearing sleeve after the pressing-in of the sliding sleeve, wherein the magnetic element is spaced from the pin in the radial direction. The magnetic element is advantageous in particular for conducting the magnetic flux which is produced by the electromagnet for moving the pin, and for producing a closed circuit of the magnetic field lines. An effect of the magnetic forces on surrounding components is thus reduced. The magnetic element is preferably formed as a disk-shaped ring element and is inserted into the bearing sleeve after the pressing-in of the sliding sleeve into the bearing sleeve. The magnetic element is preferably likewise pressed into the bearing sleeve.

It is also preferable if the pin is in surface contact with the inner surface of the sliding sleeve, wherein the pin is arranged at a spacing from the rest of the housing of the blow-off valve. This is advantageous for producing a precisely defined guidance of the pin solely by means of the sliding sleeve.

It is moreover advantageous if two contact regions are formed between the sliding sleeve and the bearing sleeve, wherein the two contact regions are spaced from one another in the axial direction. This is advantageous for producing defined positioning of the sliding sleeve with respect to the bearing sleeve and thereby producing as small a contact surface as possible between the sliding sleeve and the bearing sleeve.

Advantageous further developments of the present invention are described in the subclaims and in the description below of the figures.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail with the aid of an exemplary embodiment with reference to the drawings. The drawings show:

FIG. 1 is a sectional view through a blow-off valve, wherein a pin is arranged centrally in the blow-off valve, which pin is connected on one side to a piston and is moved by an electromagnetic force, wherein the pin is supported in a sliding sleeve; and

FIG. 2 is a perspective view of four elements of the blow-off valve shown in FIG. 1, wherein the sliding sleeve, the bearing sleeve, the pin and the magnetic element are shown in particular.

### DETAILED DESCRIPTION OF THE PREFERRED EMBODIMENTS

The following description of the preferred embodiment(s) is merely exemplary in nature and is in no way intended to limit the invention, its application, or uses.

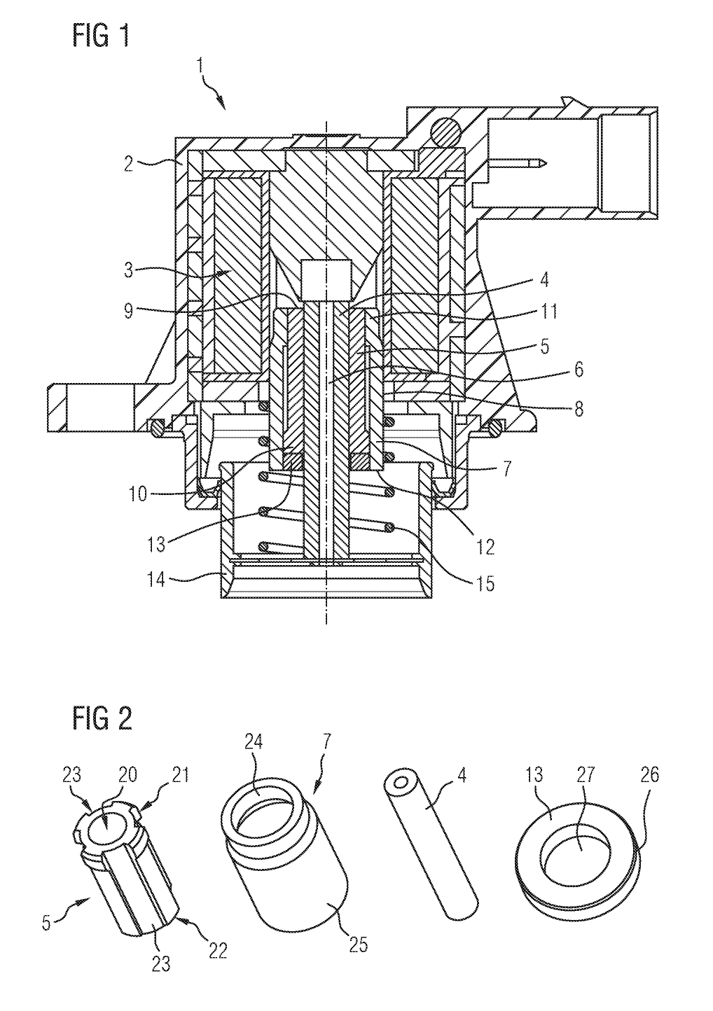

FIG. 1 shows a blow-off valve 1. The blow-off valve 1 has a housing 2 through which a flow may pass along a flow section. An electromagnet 3 is arranged in the housing 2, which electromagnet 3 is powered by a voltage source (not illustrated) whereby electromagnetic forces are produced, which act on the pin 4 arranged in the blow-off valve 1. The pin 4 is formed in the shape of a rod with a circular cross-section and has a central axial through-bore 6 extending through it in the exemplary embodiment of FIG. 1.

The pin 4 is guided in a sliding sleeve 5 and may be moved upward and downward relative to the sliding sleeve 5 in a translatory direction. The sliding sleeve 5 is formed as a tubular body and surrounds the pin 4 completely in the circumferential direction.

The sliding sleeve 5 is received in a bearing sleeve 7, which is in turn received in a suitable opening 8 in the housing 2. The sliding sleeve 5 and the bearing sleeve 7 are pressed together.

The sliding sleeve 5 has a smaller outer diameter at its upwardly directed end region 9 than at its downwardly directed end region 10. The bearing sleeve 7 has a smaller inner diameter at its upper end region 11 than at its lower end region 12. The sliding sleeve 5 may be introduced into the bearing sleeve 7 from below owing to the differing inner diameter and outer diameter, since an air gap is initially created between the inner surface of the bearing sleeve 7 and the outer surface of the sliding sleeve 5. If, during assembly, the upper end region 9 of the sliding sleeve 5 arrives at the upper end region 11 of the bearing sleeve 7, contact is generated between the sliding sleeve 5 and the bearing sleeve 7. At the same time, contact is generated here between the lower end regions 10 and 12 so that the sliding sleeve 5 ultimately abuts against the bearing sleeve 7 via two contact regions. Between the contact regions, clearances are generated between the sliding sleeve 5 and the bearing sleeve 7.

A magnetic element 13 is inserted into the bearing sleeve 7 below the sliding sleeve 5. The magnetic element 13 serves primarily for shielding the elements of the blow-off valve 1 below the sliding sleeve 5 from the magnetic field lines produced by the electromagnet 3. The magnetic element 13 is formed as a disk-shaped ring element in FIG. 1.

A detailed description of the design of the sliding sleeve 5, the bearing sleeve 7, the pin 4 and the magnetic element 13 follows in the description of FIG. 2.

Through an upward and downward movement of the pin 4, the piston 14 shown in FIG. 1 is moved in opposition to a spring force of the spring element 15. As a result, a flow path through the blow-off valve may be opened or this flow path may be closed.

FIG. 2 shows four elements of the blow-off valve 1 of FIG. 1. A perspective view of the sliding sleeve 5 is shown on the far left. The sliding sleeve 5 is formed as a tubular body having a central through-bore 20. It is possible to see the region having a larger outer diameter 21 and the region 22 having an outer diameter which is smaller than that of the region 21. Extending in the circumferential direction, the sliding sleeve 5 has four recesses 23, which are arranged spaced from one another through 90 degrees in the circumferential direction and extend over the entire length of the sliding sleeve 5 in the axial direction. With the inner surface of the bearing sleeve 7, these recesses form channels through which it is possible to achieve a pressure equalization between the cavities above the sliding sleeve 5 and below the sliding sleeve 5.

Shown next to this on the right is the bearing sleeve 7, which likewise corresponds to a tubular body. It is possible to see, in particular, the portion 24 having a smaller inner diameter and the portion 25 having a larger inner diameter. As could already be seen in FIG. 1, the bearing sleeve has a substantially constant wall thickness in the axial direction. The bearing sleeve 7 in FIG. 2 is shown in the same alignment as in FIG. 1. The sliding sleeve 5, on the other hand, is shown rotated through approximately 180 degrees.

The pin 4, which has a central through-bore extending in the axial direction, is shown as the second element from the right. This bore may likewise serve for the pressure equalization above and below the sliding sleeve 5. The outer dimensions of the pin 4 are selected such that the pin 4 may slide along the inner surfaces of the sliding sleeve 5. To this end, the sliding sleeve 5 also has, in particular, a constant inner diameter.

The magnetic element 13, which is formed as a disk-shaped ring element, is shown on the far right. The magnetic element has, at least on its upwardly directed edge extending along the outer circumference, a sloping chamfer 26 which, in particular, facilitates the insertion into the bearing sleeve 7. The magnetic element 13 is dimensioned such that it may be trapped with respect to the inner wall of the bearing sleeve 7. The bore 27 through the magnetic element 13 is dimensioned such that the pin 4 is guided freely and without contact through the bore 27.

FIGS. 1 and 2 show, in particular, a specific construction of a blow-off valve 1 and, in particular, the bearing of the pin 4 within the housing 2. It is also possible to provide alternative structural designs of the bearing sleeve 7, the sliding sleeve 5 and the pin 4 within the scope of the invention, such that the feature of the bearing of the pin 4 is realized by only one bearing point in the form of a sliding sleeve.

In particular, the exemplary embodiment of FIGS. 1 and 2 is not restrictive in nature and serves to illustrate the inventive idea.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A blow-off valve for regulating the pressure in an intake section of an internal combustion engine, comprising:
a housing;
a flow section formed in the housing;
a piston moved by means of an electromagnetically producible force;
a valve seat, the flow section is opened when the piston is moved away from the valve seat, and the flow section is closed when the piston is seated on the valve seat;
a pin connected to the piston such that movement of the pin is transferred to the piston;
a sliding sleeve;
wherein the bearing of the pin within the blow-off valve is supported by the sliding sleeve, such that the pin is movable relative to the sliding sleeve.

2. The blow-off valve of claim 1, wherein the inner lateral surface of the sliding sleeve follows the outer lateral surface of the pin, such that a fit is created between the sliding sleeve and the pin which enables the pin to slide in the sliding sleeve.

3. The blow-off valve of claim 1, further comprising:
a bearing sleeve;
wherein the sliding sleeve is received in the bearing sleeve, and the bearing sleeve is arranged in the housing of the blow-off valve.

4. The blow-off valve of claim 3, wherein the sliding sleeve is pressed into the bearing sleeve.

5. The blow-off valve of claim 4, further comprising:
a first portion being part of the bearing sleeve, the first portion having a first inner diameter; and
a second portion being part of the bearing sleeve, the second portion having a second inner diameter;
wherein the first inner diameter is smaller than the second inner diameter.

6. The blow-off valve of claim 5, further comprising:
a magnetic element is arranged in the portion having the second inner diameter of the bearing sleeve, such that the magnetic element is inserted into the bearing sleeve after the sliding sleeve is pressed into the bearing sleeve;
wherein the magnetic element is spaced from the pin in the radial direction.

7. The blow-off valve of claim 5, further comprising:
a first region being part of the sliding sleeve, the first region having a first outer diameter; and
a second region being part of the sliding sleeve, the second region having a second outer diameter;
wherein the first outer diameter is smaller than the second outer diameter.

8. The blow-off valve of claim 7, wherein the sliding sleeve abuts with the outer surface of the first region against the inner surface of the first portion of the bearing sleeve and the sliding sleeve abuts with the outer surface of the second region against the inner surface of the second portion of the bearing sleeve.

9. The blow-off valve of claim 3, wherein the bearing sleeve is pressed into the housing.

10. The blow-off valve of claim 3, further comprising two contact regions formed between the sliding sleeve and the bearing sleeve, wherein the two contact regions are spaced from one another in the axial direction.

11. The blow-off valve of claim 1, the sliding sleeve further comprising:
a plurality of recesses extending along the outer surface of the sliding sleeve in the axial direction;
wherein the outer surface of the sliding sleeve is divided into segments which are spaced from one another in the circumferential direction.

12. The blow-off valve if claim 1, wherein the pin is in surface contact with the inner surface of the sliding sleeve, and the pin is arranged at a spacing from the rest of the housing of the blow-off valve.
